(19) United States
(12) Patent Application Publication
(10) Pub. No.: US 2026/0034387 A1
(43) Pub. Date: Feb. 5, 2026

(54) RESPIRATORY SYSTEM, IN PARTICULAR FOR AN AIRCRAFT

(71) Applicant: SAFRAN AEROSYSTEMS, PLAISIR (FR)

(72) Inventors: Matthieu Luc FROMAGE, MOISSY-CRAMAYEL (FR); Nicolas BLOCH, MOISSY-CRAMAYEL (FR)

(21) Appl. No.: 18/997,614

(22) PCT Filed: Jul. 17, 2023
(86) PCT No.: PCT/FR2023/051099

§ 371 Date: Jan. 22, 2025

(30) Foreign Application Priority Data
Jul. 27, 2022 (FR) FR2207747

(51) Int. Cl. A62B 7/14; A62B 7/02

(52) U.S. Cl. CPC A62B 7/14; A62B 7/02

(57) ABSTRACT

Breathing system, in particular for an aircraft, having a remote regulator which includes a chamber, a gas mixture inlet, leading into the chamber via an intake valve, a gas mixture outlet that is open to the chamber, and a regulating means for regulating a pressure in the chamber. The breathing system also includes a breathing mask having a pressure sensor for measuring a pressure in an internal space, a pipe connecting the gas mixture outlet to the mask, an inlet valve, adapted to deliver a diluent gas into the internal space, and a control system connected to the pressure sensor and to the regulating means and configured to control the intake valve and/or the diluent gas inlet valve.

### TECHNICAL FIELD OF THE INVENTION

The invention relates to regulating a proportion of oxygen delivered by a breathing system for the occupants of an aircraft. More specifically, the invention relates to a breathing system with a remote regulator, for an aircraft.

### PRIOR ART

The delivery of a gas mixture containing oxygen to the occupants of an aircraft through a mask connected to a source of breathable gas. Such a source of breathable gas can deliver a gas mixture which may include oxygen or air highly enriched with oxygen, stored in one or more cylinders or in reserves of pressurized oxygen arranged on board the aircraft.

The oxygen supply may be replaced by an onboard oxygen generation system, such as one or more onboard oxygen generation systems (also referred to by the acronym OBOGS) supplied with air from the compressor of one or more of the engines.

The onboard oxygen generation system may also comprise a molecular sieve oxygen generating system (also referred to by the acronym MSOGS) arranged to provide oxygen-enriched air at a desired oxygen concentration by adsorbing nitrogen from the air supplied to the system.

Such distribution is intended to ensure that the occupants are protected against hypoxia, for example in the event of depressurization of the aircraft cabin, against the presence of smoke and/or vapors in the aircraft cabin, in particular in the event of an accident, or against the effects of acceleration, in the case of military aircraft.

The gas mixture may also comprise a diluent gas, for example ambient air or air from a source of compressed air.

The gas mixture is distributed by a breathing system, through a pipe connected to the mask placed on the face of a user, in particular by means of an elastic or mechanical harness.

The breathing system comprises a regulating device that regulates the proportion of oxygen delivered in the gas mixture, as well as a system for controlling the pressure in the pipe connected to the mask and in the mask.

The regulator may be located on the mask, as described in document U.S. Pat. No. 9,227,091. Such a regulator carried on the mask constitutes a significant forward load on the wearer's face, added to the weight of the pipe. This causes unpleasant stresses in the event of prolonged use.

Alternatively, the regulator may be moved to the other end of the pipe, at the air and oxygen inlets, as described in document EP 0 263 677. However, the diameter of the pipe must then be increased in order to be able to provide a suitable flow rate. This again creates a forward load on the mask wearer's head and a shift in the center of gravity, making it uncomfortable to wear the mask for long periods.

In addition, such a remote regulator requires taking into account a pressure drop in the pipe upstream of the mask in order to avoid discomfort in breathing. One solution to this problem is provided in document U.S. Pat. No. 3,249,107, by adding a second pipe. However, such a modification results in a significant increase in the off-center mass and increases the rigidity of the system, which is detrimental to user comfort.

Another solution, proposed in document EP 0 500 407, consists of compensating for the pressure drop pneumatically by modifying the pressure at which the gas mixture is injected into the pipe and by considering that the pressure drop evolves quadratically. However, such compensation cannot perfectly compensate for the pressure drop, since the pressure drop does not exactly correspond to the quadratic model. This prevents using a pipe of small diameter, for which the quadratic model is poorly suited. It results in pressure oscillations in the pipe, which are unpleasant for the user. This phenomenon is amplified in a pipe of small diameter.

In addition, remote regulators use an inhalation valve mounted between the mask and the pipe, to prevent backflow in the pipe during exhalation. Such a valve generates an additional drop in pressure, further reducing user comfort in breathing.

Furthermore, the regulators used in military or commercial aircraft are designed to operate in several different modes, the number of modes possibly differing in military versus commercial aircraft; these modes are selected manually by means of a lever or rotary knob and are managed by purely mechanical components such as valves.

These modes include in particular: the distribution of a mixture of oxygen and diluent gas in order to preserve the oxygen reserves; the distribution of pure oxygen; the distribution of pure oxygen at an overpressure relative to the pressure in the passenger compartment in order to protect the user against gaseous pollutants for example; and/or the distribution of pure oxygen in a continuous flow in order to compensate for any failure of the regulator.

Another desirable mode relates to preventive wearing of the mask, in which only ambient air is flowing in the mask. This preventive mode allows switching more quickly to one of the other modes if necessary.

Current regulators are also known which allow varying the proportion of oxygen in the gas mixture, by means of a venturi tube. The injection of oxygen, by means of an injector supplied with pressurized oxygen, draws in the ambient air by the Venturi effect, through a channel that is in communication with the outside. This channel in communication with the outside comprises an altimeter capsule which gradually closes the channel when the altitude increases, thus reducing the proportion of air drawn in and thus increasing the proportion of oxygen.

With such a venturi system, the greater the pressure drop between the regulator and the mask, the more it is necessary to inject pressurized oxygen in order to draw air to the mask.

These systems therefore have a minimum enrichment rate which depends in particular on the diameter of the pipe. These are inconsistent with use at a low or zero enrichment level in cases of preventive use.

### PRESENTATION OF THE INVENTION

The invention aims to remedy the above disadvantages by proposing a breathing system, in particular for an aircraft, which allows distributing a gas mixture through a mask while providing adequate breathing comfort and satisfactory wearing for a long period.

To this end, the invention relates to a breathing system, in particular for an aircraft, comprising:
a remote regulator, comprising:
   a chamber,
   at least one gas mixture inlet connected to a source of breathable gas, leading into the chamber via a gas mixture intake valve,
   a gas mixture outlet that is open to the chamber, and
   at least one regulating means for regulating the pressure in the chamber,
a breathing mask intended to be placed on a user's face and defining an internal space, comprising a pressure sensor adapted to measure a pressure in the internal space,
at least one pipe fluidically connecting the gas mixture outlet of the regulator to the mask,
at least one diluent gas inlet valve, adapted to deliver a diluent gas into the internal space and/or into the chamber, and
at least one control system connected to the pressure sensor and to the regulating means and configured to control the gas mixture intake valve and/or the diluent gas inlet valve.

Such a breathing system makes it possible to implement the four operating modes described above in a fully automated manner. In addition, this breathing system makes it possible to prevent the occurrence of pressure oscillations in the pipe, and to reduce the diameter of the pipe in order to improve user comfort during prolonged wearing of the mask.

Such a remote regulator is, for example, mounted on a fixed structure of the aircraft such as on a seat, on a dashboard, or in a storage box.

The breathable gas is, for example, oxygen from a pressurized bottle and/or from an on-demand oxygen generation device. The diluent gas is, for example, ambient air.

The diluent gas inlet valve may be located on the mask and open directly into the internal space.

The regulating means may comprise at least one pressure sensor adapted to measure a pressure in the chamber and connected to the control system.

Such a sensor allows a direct measurement of the pressure in the chamber and thus an effective regulation by the control system.

The regulating means may comprise at least one flow sensor adapted to measure a gas flow rate through the inlet and/or through the outlet of the regulator, each flow sensor being connected to the control system.

Such a sensor allows directly measuring the gas flow rates delivered.

The flow sensors may be arranged to measure the flow rate of incoming breathable gas, the flow rate of incoming diluent gas, and/or the flow rate of the gas mixture, delivered into the pipe or into the internal space of the mask.

The regulating means may comprise at least one mechanical element arranged to be subjected to a force exerted by the pressure in the chamber and to transmit a return force so as to mechanically control the gas mixture intake valve.

Such a sensor makes it possible to implement passive mechanical regulation without requiring an electronic system, which may be combined with electronic regulation in order to supplement it in the event of an incident, for example.

As an example, the mechanical element may comprise an elastic membrane or a compression spring.

The pipe may lead into the internal space of the mask through an inhalation valve. Such a configuration makes it possible to avoid a return flow of exhaled gases into the pipe.

The mask may comprise an exhalation valve, in particular regulated by an internal pressure of the pipe. Thus arranged, it is possible to ensure that the overpressure is maintained within the internal space of the mask.

The pipe may have an internal cross-sectional area that is less than or equal to 150 mm², in particular less than or equal to 115 mm², more particularly less than or equal to 80 mm², more specifically less than or equal to 80 mm².

Such dimensions allow reducing the weight of the pipe, offset relative to the user's face, and thus improving user comfort in wearing the mask for a long period.

The diluent gas inlet valve may lead into the regulator chamber and be connected to a source of breathable gas, in particular a second source of breathable gas, in particular a source of compressed air.

Such a feature makes it possible to implement the dilution of the breathable gas at the regulator.

The regulator may comprise a damping device, in particular a secondary chamber, in fluid communication with the chamber, in particular via a constriction, the device being adapted to filter out pressure oscillations in the chamber.

The damping device comprises, for example, a secondary chamber connected to the chamber by at least one constriction. The volume of the secondary chamber and the diameter of the constriction are chosen so as to filter out pressure oscillations related to the pneumatic circuit.

The chamber and the secondary chamber are mounted in parallel fluidically.

Alternatively, the damping device may comprise a separator provided with at least one constriction, dividing the chamber into two successive chambers mounted in series fluidically. A number of chambers greater than two may be envisaged, mounted in parallel and/or in series fluidically.

Alternatively, the damping device may comprise a laminar outlet orifice and a membrane arranged in the chamber.

Alternatively, the damping device may comprise a membrane expansion tank.

The regulator may comprise a pressure sensor and/or a pressure regulator arranged upstream of the gas mixture intake valve and respectively configured to measure and/or regulate a pressure of the breathable gas mixture from the source.

This feature makes it possible to avoid pressure variations from the breathable gas source.

The pressure sensor and/or the pressure regulator are in particular controlled by the control system.

Of course, the different features, variants, and/or embodiments of the present invention may be associated with each other in various combinations, to the extent that they are not incompatible or mutually exclusive.

### BRIEF DESCRIPTION OF FIGURES

The invention will be better understood and other features and advantages will become apparent upon reading the detailed description which follows, comprising embodiments given for illustrative purposes with reference to the appended figures and presented as non-limiting examples, which may serve to complete one's understanding of the invention and the description of its implementation and, where appropriate, contribute to its definition, in which:

FIG. 1 is a schematic view of a breathing system according to a first embodiment of the invention,

FIG. 2 is a schematic view of a breathing system according to a second embodiment of the invention,

FIG. 3 is a schematic view of a breathing system according to a third embodiment of the invention,

FIG. 4 is a schematic view of a breathing system according to a fourth embodiment of the invention, and

FIG. 5 is a schematic view of a breathing system according to a fifth embodiment of the invention.

### DETAILED DESCRIPTION OF THE INVENTION

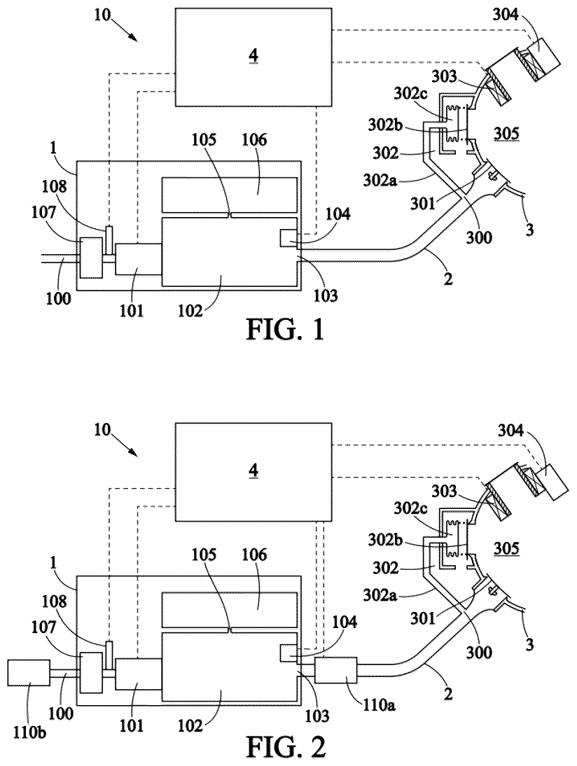

A breathing system 10, in particular for an aircraft, according to a first embodiment of the invention is shown in a schematic view in FIG. 1. Such a breathing system 10 is intended to deliver or distribute a gas mixture comprising a breathable gas, to at least one occupant of an aircraft. The distribution of a gas mixture may take place from a source of breathable gas. Such a source of breathable gas may be a gas mixture that may include oxygen or air highly enriched with oxygen, stored in one or more cylinders or in reserves of pressurized oxygen arranged on board the aircraft.

The oxygen supply may be replaced by an onboard oxygen generation system, such as one or more onboard oxygen generator systems (also referred to by the acronym OBOGS) supplied with air from the compressor of one or more of the engines.

The onboard oxygen generation system may also comprise a molecular sieve oxygen generating system (also referred to by the acronym MSOGS) arranged to provide oxygen-enriched air at a desired oxygen concentration by adsorbing nitrogen from the air supplied to the system.

The occupant may be, for example, a pilot of the aircraft, whose vigilance and performance are crucial at all times. He must therefore receive a proportion of oxygen adapted to the critical situation that he is facing, over long periods.

Breathing system 10 comprises a regulator 1, capable of delivering a gas flow into a distribution member. The distribution member comprises at least one pipe 2 suitable for allowing the circulation of the gas mixture comprising breathable gas, and a mask 3 intended for distributing the gas mixture comprising breathable gas to the occupant.

Breathing system 10 also comprises a control system 4.

According to one exemplary embodiment of the invention, regulator 1 is an on-demand regulator, i.e. configured to deliver the gas flow when the occupant inhales.

For this purpose, regulator 1 comprises a gas mixture inlet 100, in particular a first gas mixture inlet 100. Gas mixture inlet 100 may be connected to a source of breathable gas, in particular a first source of breathable gas, for example pure oxygen from a pressurized cylinder.

Gas mixture inlet 100 is provided with a gas mixture intake valve 101, in particular a first gas mixture intake valve 101, adapted to regulate the flow rate of the gas mixture flowing through gas mixture inlet 100.

Gas mixture intake valve 101 is in particular an electronic valve comprising a control device adapted for continuously controlling the progressive opening of gas mixture intake valve 101. In particular, gas mixture intake valve 101 advantageously has very rapid dynamics in its opening and closing, for example greater than or equal to 10 Hz, meaning that gas mixture intake valve 101 can open or close in less than a tenth of a second, in particular on command from control system 4.

The control device of gas mixture intake valve 101 is, for example, piezoelectric, electromagnetic, electrostatic, pneumatic, or some other type. It may be, for example, a linear or rotary actuator.

Furthermore, gas mixture intake valve 101 is able to be of the amplified or direct control type, in particular via a pneumatic system amplifying a control signal provided by control device 4 of gas mixture intake valve 101, in particular the electrical control device of gas mixture intake valve 101.

Gas mixture inlet 100 leads into a chamber 102 of regulator 1. Chamber 102 of regulator 1 comprises a gas mixture outlet 103 that is connected fluidically to pipe 2.

Chamber 102 is a sealed chamber. Furthermore, according to one particular embodiment, chamber 102 may comprise at least one pressure regulating means which regulates the pressure of the gas mixture present in chamber 102.

In the first embodiment shown in FIG. 1, the pressure regulating means comprises at least one pressure sensor 104. Pressure sensor 104 is arranged to measure a pressure in chamber 102, in particular under the control of control system 4. Thus configured, control system 4 controls the control device of gas mixture intake valve 101.

Regulator 1 may also comprise a damping device, such as a pneumatic damper. According to this alternative, the damping device comprises a secondary chamber 106, preferably fluidically connected to main chamber 102. The fluidic connection between main chamber 102 and secondary chamber 106 may be achieved by a constriction 105. In such a configuration, secondary chamber 106 may thus be considered to be mounted in parallel fluidically with main chamber 102.

In order to fulfill a role as damping device, the volume of secondary chamber 106 and the diameter of constriction 105 are both chosen so as to dampen pressure oscillations in main chamber 102. According to one variant, the damping device, in particular the pneumatic damper, comprises a divider separating main chamber 102 into two sub-chambers mounted in series fluidically. For this purpose, the divider separating main chamber 102 comprises a constriction providing the fluidic connection between the two sub-chambers mounted in series. Thus, gas mixture inlet 100 is arranged on one side of the divider and gas mixture outlet 103 is arranged on the other side of the divider.

The number of chambers is not limited to two. A greater number of chambers may be envisaged, the plurality of chambers present being mounted in parallel and/or in series fluidically.

Alternatively, the damping device, in particular the pneumatic damper, may comprise a laminar outlet orifice and a membrane arranged in main chamber 102 and/or secondary chamber 106.

According to another alternative, the damping device, in particular the pneumatic damper, may comprise a membrane expansion tank.

Regulator 1 may also comprise a pressure sensor 108, in particular a first pressure sensor 108, and/or a pressure regulator 107, in particular a first pressure regulator 107. In such a case, pressure sensor 108 and/or pressure regulator 107 is/are mounted on inlet 100, upstream of gas mixture intake valve 101. Advantageously, pressure sensor 108 and/or pressure regulator 107 is/are controlled by control system 4.

Pressure sensor 108 and pressure regulator 107 make it possible to avoid pressure variations in the gas mixture from the breathable gas source, by measuring and compensating for possible pressure variations upstream of gas mixture intake valve 101.

Pipe 2 is advantageously flexible, or at least partly flexible, in particular in a portion connected to mask 3. A first end of pipe 2 is connected to gas mixture outlet 103 of regulator 1. A second end of pipe 2 is connected to mask 3. Pipe 2 provides a fluidic connection between gas mixture outlet 103 and mask 3, such that the breathable gas mixture flowing through gas mixture intake valve 101 is delivered to the wearer of mask 3.

Pipe 2 is advantageously a pipe of small diameter and preferably has a low weight in order to exert only moderate discomfort in the event of prolonged wearing of mask 3.

For example, an internal cross-sectional area of pipe 2 may be less than or equal to 150 mm², in particular less than or equal to 115 mm², more particularly less than or equal to 85 mm², more specifically less than or equal to 80 mm².

Mask 3 is an orinasal mask, able to be placed on the face of the occupant, or wearer, to whom the gas mixture comprising breathable gas is to be delivered. It is preferably arranged in a sealed manner on the face of the wearer of mask 3. For this purpose, mask 3 may be provided with a retention device for ensuring that mask 3 is held on the face of the occupant. Such a retention device is, for example, an elastic harness, a bayonet fastening system, or a mechanical harness. Mask 3 is generally concave in shape and defines an internal space 305. When mask 3 is fixed to the wearer's face, the wearer's skin closes off internal space 305.

The gas mixture comprising breathable gas is distributed into internal space 305 so that the wearer of mask 3 can inhale it and also exhale it.

Mask 3 comprises a mask inlet 300 connected to the second end of pipe 2. According to one exemplary embodiment, mask inlet 300 is provided with an inhalation valve 301 which pipe 2 leads to. Inhalation valve 301 is suitable for allowing the gas mixture comprising breathable gas to enter from pipe 2 into internal space 305.

In addition, mask 3 may also comprise a diluent gas inlet valve 303, in particular a first diluent gas inlet valve 303, which is open to the outside of mask 3. Diluent gas inlet valve 303 is suitable for allowing a diluent gas to enter internal space 305, in particular a diluent gas coming from the outside environment.

Mask 3 also advantageously comprises an exhalation valve 302. Exhalation valve 302 is suitable for allowing the expulsion of gases exhaled by the wearer. Exhalation valve 302 may comprise an exhalation flap 302b. Exhalation flap 302b may be urged to the closed position by an elastic element.

Exhalation valve 302 may also comprise a compensation chamber 302c in which a compensation pressure Pc is prevailing. In addition, exhalation valve 302 may also comprise a communication channel 302a suitable for connecting compensation chamber 302 to pipe 2 of regulator 1, in particular at mask inlet 300 of mask 3.

According to one particular alternative of the invention, exhalation flap 302b is designed such that the compensation pressure Pc prevailing in compensation chamber 302c and a pressure P prevailing in internal space 305 of mask 3 are applied to comparable surfaces of exhalation flap 302b. As a result, as long as pressure P in internal space 305 is lower than compensation pressure Pc, exhalation flap 302b is closed.

During exhalation at overpressure, i.e. when pressure P in internal space 305 exceeds compensation pressure Pc in compensation chamber 302c, exhalation flap 302b opens. The gases exhaled by the wearer may then be discharged out of mask 3.

This allows the gases to exit from internal space 305, between mask 3 and the wearer's skin, only when pressure P in internal space 305 exceeds the pressure in pipe 2. This makes it possible to maintain the overpressure in internal space 305.

Mask 3 further comprises a pressure sensor 304 adapted to measure pressure P in internal space 305. Pressure sensor 304 of mask 3 is advantageously connected to control system 4. The measurement of pressure P in internal space 305 makes it possible in particular to detect the wearer's inhalations and to deliver the gas mixture comprising the required breathable gas.

Control system 4 is, for example, a circuit board comprising at least one processor adapted to execute programs, and at least one memory in which instructions for the execution of these programs are stored.

According to another embodiment, control system 4 may also be completely analog. Control system 4 may also comprise control logic or control electronics and power electronics for controlling gas mixture intake valve 101.

Control system 4 is configured in particular for controlling breathing system 10 in various desired operating modes, in particular four desired operating modes, and allows selecting the operating mode automatically or via an interface, depending on the circumstances.

A first operating mode ensures a delivery of undiluted oxygen at ambient pressure. In the first operating mode, diluent gas inlet valve 303 is kept closed.

When the wearer inhales, this defines the inhalation demand which forms a negative pressure in internal space 305. As a result, inhalation valve 301 opens, allowing communication between pipe 2 and internal space 305 of mask 3.

In parallel, pressure sensor 104 located in chamber 102 of regulator 1 and pressure sensor 304 of mask 3, in particular mounted on mask 3, are used by control system 4 to control gas mixture intake valve 101 and allow the gas mixture comprising breathable gas to enter chamber 102.

At the end of the inhalation phase, the pressures at mask 3, pipe 2, and chamber 102 of regulator 1 stabilize around the ambient pressure. Gas mixture intake valve 101 is then closed.

In the exhalation phase, exhalation valve 302 opens under the effect of the excess pressure in internal space 305 due to the exhalation, allowing the exhaled gases to be discharged to outside mask 3.

The second operating mode ensures a delivery of undiluted oxygen at overpressure. The second operating mode is similar to the first operating mode except that diluent gas inlet valve 303 is kept closed.

To achieve overpressure in internal space 305, also called the orinasal cavity, gas mixture intake valve 101 allows the gas mixture comprising breathable gas to be supplied to mask 3 as long as the pressure measured by pressure sensor 304 in internal space 305 is lower than the targeted overpressure.

At the end of the inhalation phase, the pressures in mask 3 and in chamber 102 stabilize around the targeted overpressure. Control system 4 orders the closing of gas mixture intake valve 101.

The exhaled gases are discharged via exhalation valve 302. This thus allows maintaining a pressure in internal space 305 that is close to or substantially equal to the pressure in pipe 2, regulated by means of pressure sensor 104.

The third operating mode ensures a supply of the gas mixture comprising breathable gas and diluent gas. This allows protecting the wearer of mask 3 against the effects of hyperoxia.

Indeed, under certain conditions, it may be necessary to dilute the gas mixture comprising breathable gas coming from the breathable gas source, in particular the enriched oxygen source, with diluent gas, in particular ambient air. This therefore allows protecting the wearer of mask 3 against the effects of hyperoxia. This also allows optimizing autonomy, etc.

To do this, control system 4 controls the opening of diluent gas inlet valve 303 in parallel with supplying the gas mixture comprising breathable gas, according to a desired dilution level, i.e. the proportion between the gas mixture comprising breathable gas and the diluent gas.

The fourth operating mode corresponds to the extreme case where it is desired to supply entirely ambient air to the wearer of mask 3. This allows the preventive wearing of mask 3 without consuming the gas mixture comprising breathable gas, in particular from an oxygen reserve. Diluent gas inlet valve 303 of mask 3 is then open and gas mixture intake valve 101 is closed.

FIGS. 1 to 5 show different embodiments of the invention. As a result, the structural and/or functional elements common to the different embodiments may have the same references. Thus, unless otherwise stated, such elements have identical structural, dimensional and material properties and a similar operation.

A second embodiment of the invention is shown in FIG. 2 in a schematic view. The second embodiment is identical to the first embodiment of the invention shown in FIG. 1 except for a few aspects which will be described below.

In the second embodiment, the pressure regulating means which regulates the pressure in the chamber 102 comprises at least one flow sensor 110, in particular at least a first flow sensor 110a and/or at least a second flow sensor 110b. Flow sensor 110, in particular first flow sensor 110a and second flow sensor 110b, supplement(s) or replaces pressure sensor 104.

Each flow sensor 110 is, for example, a thermal sensor, in particular of the hot-wire probe type, a sonic sensor, in particular of the Doppler effect type, a mechanical sensor, in particular of the cantilever or Coriolis effect type, or a pressure loss sensor, in particular of the venturi, laminar, orifice plate type, etc.

More specifically, first flow sensor 110a, respectively second flow sensor 110b, may be a thermal sensor, in particular of the hot-wire probe type, a sonic sensor, in particular of the Doppler effect type, a mechanical sensor, in particular of the cantilever or Coriolis effect type, or a pressure loss sensor, in particular of the venturi, laminar, orifice plate type, etc.

In particular, first flow sensor 110a and second flow sensor 110b may be of different types. Pressure sensors positioned according to the geometry of the valves and pipes also make it possible to obtain a flow rate value in an equivalent manner, according to Bernoulli's principle or Poiseuille's law.

According to one particular embodiment, first flow sensor 110a may be mounted so as to measure a flow rate of the gas mixture comprising breathable gas, through gas mixture outlet 103. Additionally or alternatively, second flow sensor 110b may be mounted so as to measure a flow rate of the gas mixture comprising breathable gas, through gas mixture inlet 100.

Preferably, first flow sensor 110a, respectively second flow sensor 110b, is connected to control system 4. In such a configuration, control system 4 is configured to adapt the supply of gas mixture comprising breathable gas according to the inlet and outlet flow rates and, advantageously, the control device of gas mixture intake valve 101, in particular the pneumatic system downstream of gas mixture intake valve 101.

Furthermore, first flow sensor 110a, respectively second flow sensor 110b, provides flow rate information for the gas mixture comprising breathable gas that is delivered to the wearer of mask 3, which is highly advantageous for calculating the dilution rate in the third operating mode described above, in which the gas mixture comprising breathable gas and the diluent gas are supplied.

Alternatively, a single flow sensor 110 may be used, at gas mixture inlet 100 or gas mixture outlet 103.

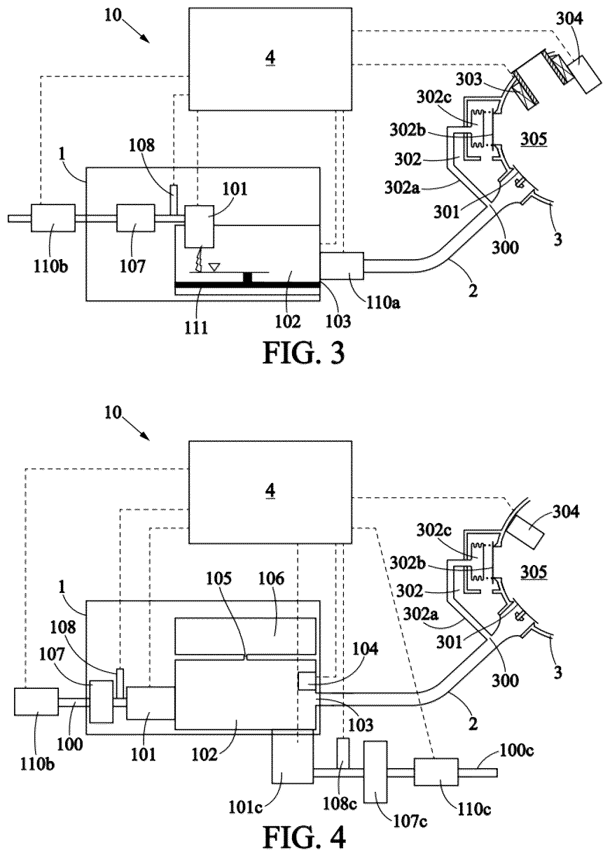

A third embodiment is schematically represented in FIG. 3. The third embodiment is identical to the second embodiment of the invention represented in FIG. 2, except for a few aspects which will be described below.

In the third embodiment, the pressure regulating means which regulates the pressure in chamber 102 comprises at least one mechanical element 111, in particular at least one membrane 111, more particularly at least one elastic membrane 111. The pressure in chamber 102 is exerted on mechanical element 111, specifically on membrane 111.

According to one particular arrangement of the invention, mechanical element 111 is connected to gas mixture intake valve 101. Thus arranged, mechanical element 111, in particular elastic membrane 111, is able to urge gas mixture intake valve 101 so as to cause it to close when the pressure exerted on mechanical element 111 exceeds the ambient pressure. Mechanical element 111 is therefore arranged to be subjected to a force exerted by the pressure in chamber 102 and to transmit a return force so as to mechanically control gas mixture intake valve 101.

This makes it possible to implement a purely mechanical regulation of the pressure in chamber 102, without involving an electronic device.

Furthermore, mechanical element 111, in particular in the form of membrane 111 or a piston, may be supplemented with an elastic element which opposes its action. Such a configuration makes it possible to implement a purely mechanical regulation in which it is possible to vary the pressure threshold that causes the closure of gas mixture intake valve 101.

A fourth embodiment is shown in FIG. 4 in a schematic view. The fourth embodiment is identical to the first embodiment of the invention shown in FIG. 1, with the exception of a few aspects which will be described below.

In the fourth embodiment, mask 3 preferably does not include a diluent gas inlet valve that is in direct communication with the outside.

According to the fourth embodiment, regulator 1 comprises a second gas mixture inlet 100c. Second gas mixture inlet 100c is able to be connected to a second source of breathable gas, in particular a source of compressed air, acting as a source of diluent gas.

According to an alternative embodiment, the first source of breathable gas and the second source of breathable gas may be one and the same source of breathable gas.

Second gas mixture inlet 100c leads into chamber 102, in particular through a diluent gas intake valve 101c, in particular a second diluent gas intake valve 101c. Second diluent gas intake valve 101c is able to be a valve similar to first gas mixture intake valve 101 and is adapted to be controlled by control system 4.

According to one particular arrangement of the fourth embodiment, first gas mixture intake valve 101 and second diluent gas intake valve 101c are respectively provided with flow sensors 110. In particular, first gas mixture intake valve 101 is provided with second flow sensor 110b, as described above in relation to FIGS. 2 and 3. Furthermore, second diluent gas inlet valve 101c is provided with a third flow sensor 110c, in particular similar to first flow sensor 110a or to second flow sensor 110b described above. Third flow sensor 110c is also part of the regulating means.

Second gas mixture inlet 100c optionally comprises a second pressure sensor 108c and/or a second pressure reducer 107c. In such a case, second pressure sensor 108c and/or second pressure regulator 107c is/are on second gas mixture inlet 100c upstream of second diluent gas inlet valve 101c. Second pressure sensor 108c and second pressure reducer 107c may respectively be similar to first pressure sensor 108 and first pressure regulator 107 which were described for first gas mixture intake valve 101.

Control system 4 is then able to regulate both the flow rate for the incoming breathable gas and the flow rate for the incoming diluent gas, by controlling first gas mixture intake valve 101 and second diluent gas inlet valve 101c, the dilution taking place in chamber 102 upstream of pipe 2 that ensures the fluidic connection between regulator 1 and mask 3.

Such a control system 4 thus allows precise regulation of the proportion of breathable gas, in particular oxygen, in the gas mixture delivered to the user who is wearing mask 3.

As a variant, control of the dilution may be carried out, additionally or alternatively, by an oxygen sensor located in chamber 102, which may then replace second flow sensor 110b and/or third flow sensor 110c. It may also be possible to use a physiological measurement of the user who is wearing mask 3, for example provided by a pulse oximeter, in order to regulate the dilution level.

Alternatively, the localized oxygen sensor is able to be arranged in pipe 2 fluidically connecting gas mixture outlet 103 of regulator 1 to mask 3.

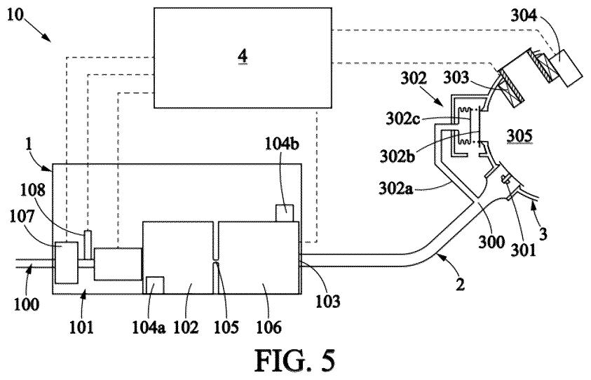

A fifth embodiment is shown in FIG. 5 in a schematic view. The fifth embodiment is identical to the first embodiment of the invention shown in FIG. 1, with the exception of a few aspects which will be described below.

In the fifth embodiment, the damping device, in particular the pneumatic damper and specifically secondary chamber 106, is arranged in series fluidically with main chamber 102, in particular upstream of main chamber 102 relative to the direction of flow of the gas mixture comprising breathable gas.

For this purpose, a divider is arranged between main chamber 102 and the damping device, in particular secondary chamber 106. In such a configuration, the divider comprises a constriction 105 ensuring the fluidic connection between main chamber 102 and the damping device which are mounted in series.

Thus, gas mixture inlet 100 is arranged on one side of the divider, in particular leading into main chamber 102, and gas mixture outlet 103 is arranged on the other side of the divider, in particular being open to secondary chamber 106.

Of course, the invention is not limited to the embodiments described above and provided solely as examples. It encompasses various modifications, alternative forms, and other variants that conceivable to those skilled in the art within the scope of the present invention, and in particular all combinations of the different operating modes described above, which may be taken separately or in combination, provided that such combinations are not incompatible with each other.

1. A breathing system for an aircraft, comprising:
a remote regulator (1), comprising:
a chamber (102),
at least one gas mixture inlet (100) connected to a source of breathable gas, leading into the chamber (102) via a gas mixture intake valve (101), and
a gas mixture outlet (103) that is open to the chamber (102), and
at least one regulating means (104, 110a, 110b, 110c, 111) for regulating a pressure in the chamber (102),
a breathing mask (3), intended to be placed on a user's face, defining an internal space (305), comprising a pressure sensor (304) adapted to measure a pressure in the internal space (305),
at least one pipe (2) fluidically connecting the gas mixture outlet (103) of the regulator (1) to the mask (3),
at least one diluent gas inlet valve (303, 101c), adapted to deliver a diluent gas into the internal space (305) and/or into the chamber (102), and
at least one control system (4) connected to the pressure sensor (304) and to the regulating means (104, 110a, 110b, 110c, 111) and configured to control the gas mixture intake valve (101) and/or the diluent gas inlet valve (303, 101c).

2. The system according to claim 1, wherein the regulating means comprises at least one pressure sensor (104) adapted to measure a pressure in the chamber (102) and connected to the control system (4).

3. The system according to claim 1, wherein the regulating means comprises at least one flow sensor (110a, 110b, 110c), adapted to measure a gas flow rate through the gas mixture inlet (100) and/or through the gas mixture outlet (103) of the regulator (1) and connected to the control system (4).

4. The system according to claim 1, wherein the regulating means comprises at least one mechanical element (111) arranged to be subjected to a force exerted by the pressure in the chamber (102) and to transmit a return force so as to mechanically control the gas mixture intake valve (101).

5. The system according to claim 1, wherein the pipe (2) leads into the internal space (305) of the mask (3) through an inhalation valve (301).

6. The system according to claim 1, wherein the mask (3) comprises an exhalation valve (302) regulated by an internal pressure of the pipe (2).

7. The system according to claim 1, wherein the pipe (2) has an internal cross-sectional area that is less than or equal to 150 mm².

8. The system according to claim 1, wherein the diluent gas inlet valve (101c) leads into the chamber (102) of the regulator (1) and is connected to a second source of breathable gas.

9. The system according to claim 1, wherein the regulator (1) comprises a damping device adapted to filter out pressure oscillations in the chamber (102).

10. The system according to claim 1, wherein the regulator (1) comprises a pressure sensor (108) and/or a pressure regulator (107) arranged upstream of the gas mixture intake valve (101) and respectively configured to measure and/or regulate a pressure of the gas mixture from the breathable gas source.

11. The system according to claim 7, wherein the pipe (2) has an internal cross-sectional area that is less than or equal to 115 mm².

12. The system according to claim 11, wherein the pipe (2) has an internal cross-sectional area that is less than or equal to 80 mm².

13. The system according to claim 8, wherein the diluent gas inlet valve (101c) is connected to a source of compressed air.

14. The system according to claim 9, wherein the damping device, comprises a secondary chamber (106) in fluid communication with the chamber (102) via a constriction (105).
